(19) United States
(12) Patent Application Publication
(10) Pub. No.: US 2025/0089816 A1
(43) Pub. Date: Mar. 20, 2025

(54) BIB WITH PACIFIER SECURED THERETO

(71) Applicant: Sachini Hewage, Sudbury (CA)

(72) Inventor: Sachini Hewage, Sudbury (CA)

(21) Appl. No.: 18/469,061

(22) Filed: Sep. 18, 2023

(51) Int. Cl. A41B 13/10; A41F 1/00

(52) U.S. Cl. CPC A41B 13/10; A41F 1/00; A61J 17/10; A61J 17/105; A61J 17/1115

(57) ABSTRACT

A bib with pacifier wherein the present invention includes a pacifier member secured proximate the upper perimeter edge thereof in a manner so as to inhibit lateral movement of the pacifier member and maintain proximity to the upper perimeter edge. The present invention includes a body that is manufactured from cloth or other suitable material. The body includes a first upper corner and a second upper corner having opposing lateral edges extending downward therefrom being joined at a midpoint. A first attachment member and a second attachment member are secured along the upper perimeter edge having a void therebetween wherein the void is in general axial alignment with the midpoint. A pacifier member is secured to the first attachment member and second attachment member. Fasteners are present at the first upper corner and second upper corner and are mateable functioning to secure the body around the neck of an infant.

### FIELD OF THE INVENTION

The present invention relates generally to infant care products, more specifically but not by way of limitation, a bib configured to be surroundably mounted a wearer's neck wherein the bib includes attachment members and wherein the attachment members have coupled thereto an infant pacifier.

### BACKGROUND

Infant bibs are well known in the art and are typically manufactured from cloth or other suitable material. Conventional infant bibs are configured to be surroundably mounted an infant's neck with a portion thereof configured to cover the front of the infant so as to inhibit any material from coming in contact with the infant that is covered by the portion of the bib.

As infants develop, they often will utilize sucking as a technique to self sooth when the infant is uncomfortable. An infant will suck on their thumb or other objects when upset as a technique to provide a calming effect. Many parents and caretakers will often utilize a pacifier wherein the infant will suck on the nipple member of the pacifier. Pacifiers are employed as an alternate to the infants thumb and can be utilized to provide more control over when the infant employs sucking as a technique of self-soothing. Pacifiers are commercially available in various sizes and shapes but most have a nipple member that extends outward from a base member wherein the base member is typically modified annular in shape and of a suitable size so as to inhibit the infant from placing the entire pacifier in their mouth. Itis quite routine for infants to lose or drop the pacifier which is most often undesirable as the pacifier can contact a contaminated surface. Furthermore, depending upon the age of the infant, the infant may not have the motor skills and dexterity to retrieve the pacifier and place back in their mouth.

Accordingly, there is a need for an infant bib wherein the bib of the present invention is configured to be surroundably mounted to an infants neck wherein the bib body further includes a first securing member and a second securing member proximate the upper perimeter edge and has a pacifier releasably secured thereto.

### SUMMARY OF THE INVENTION

It is the object of the present invention to provide an infant bib having a pacifier being configured to be surroundably mounted an infant's neck wherein the present invention includes a bib body.

Another object of the present invention is to provide a combination infant bib and pacifier to be releasably secured to an infant and maintain the pacifier adjacent the infant's mouth wherein the bib body is planar in manner having an upper perimeter edge and a first lateral edge and second lateral edge.

A further object of the present invention is to provide an infant bib having a pacifier being configured to be surroundably mounted an infant's neck that further includes a first attachment member wherein said first attachment member is secured to the bib body proximate the upper perimeter edge adjacent a midpoint thereof.

Yet a further object of the present invention is to provide a combination infant bib and pacifier to be releasably secured to an infant and maintain the pacifier adjacent the infant's mouth wherein the bib body includes a first upper corner and a second upper corner.

Still another object of the present invention is to provide an infant bib having a pacifier being configured to be surroundably mounted an infant's neck that further includes a second attachment member wherein said second attachment member is secured to the bib body proximate the upper perimeter edge adjacent the first attachment member with a void therebetween.

An additional object of the present invention is to provide a combination infant bib and pacifier to be releasably secured to an infant and maintain the pacifier adjacent the infant's mouth wherein the first upper corner and second upper corner have mateable fasteners secured thereto.

Yet a further object of the present invention is to provide an infant bib having a pacifier being configured to be surroundably mounted an infant's neck that further includes a pacifier wherein the pacifier is releasably secured to the first attachment member and the second attachment member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention; and

FIG. 2 is a detailed view of the attachment members and pacifier of present invention; and

FIG. 3 is a detailed view of the pacifier of the present invention; and

FIG. 4 is a detailed view of the attachment members of the present invention.

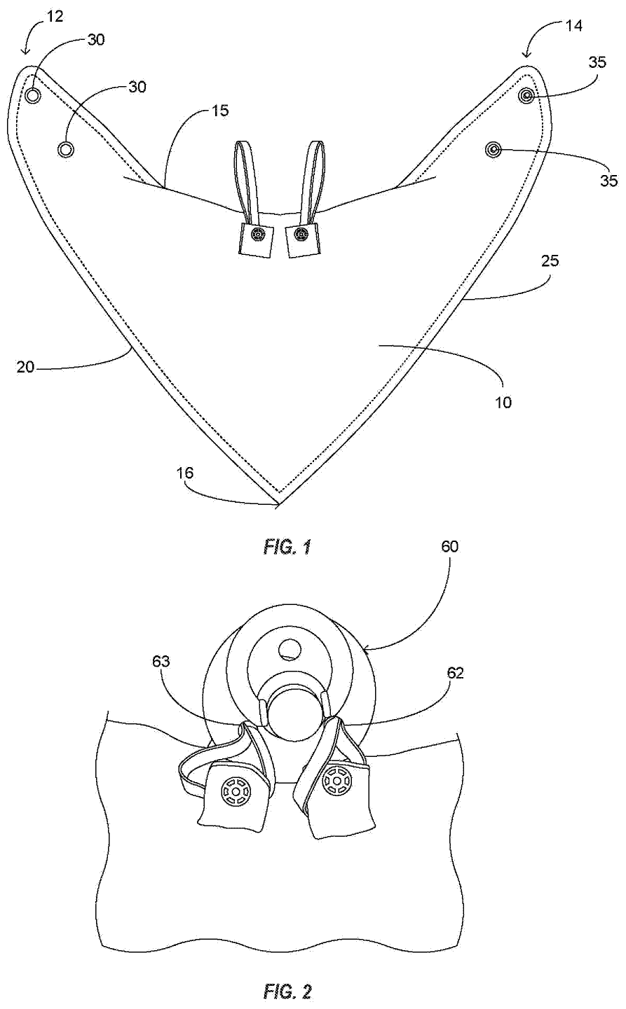

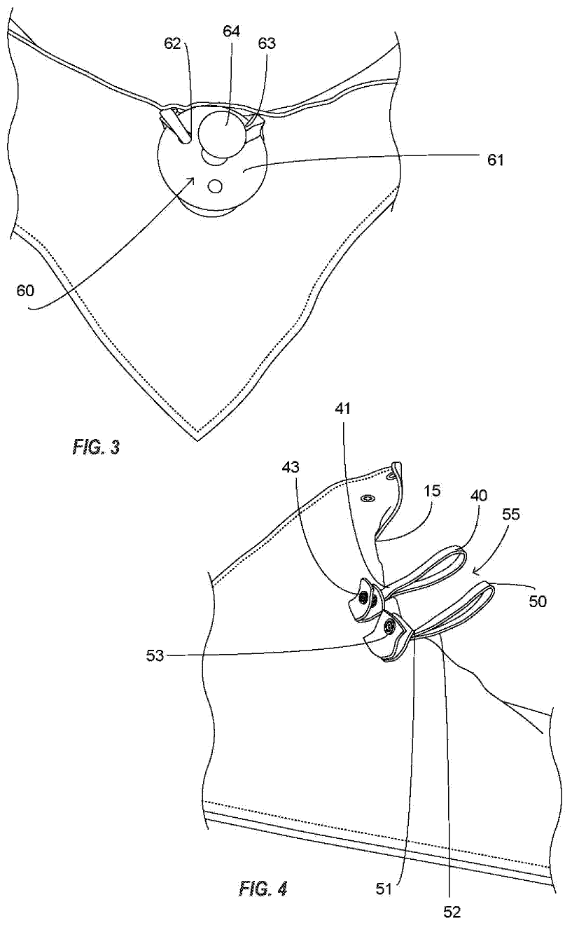

### DETAILED DESCRIPTION

Referring now to the drawings submitted herewith, wherein various elements depicted therein are not necessarily drawn to scale and wherein through the views and figures like elements are referenced with identical reference numerals, there is illustrated a bib with pacifier 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the bib with pacifier 100 includes a body 10. The body 10 is manufactured from cloth or other suitable material. It is contemplated within the scope of the present invention that the body 10 could be provided in alternate sizes and further be provided in alternate colors. The body 10 includes an upper perimeter edge 15. The upper perimeter edge 15 is adjacent to an infant's neck ensuing the bib with pacifier 100 being donned onto the infant. Contiguously formed with the upper perimeter edge 15 is the first lateral edge 20 and second lateral edge 25. The first lateral edge 20 extends downward from the first upper corner 12 while the second lateral edge 25 extends downward from the second upper corner 14. First lateral edge 20 and second lateral edge 25 converge at midpoint 16 forming a generally triangular shaped body 10 for the bib with pacifier 100.

Secured to the first upper corner 12 are fasteners 30. Fasteners 35 are secured to the second upper corner 14 utilizing suitable techniques. Fasteners 30, 35 are configured to be mateable and releasably secure to each other and are employed to secure the upper perimeter edge 15 around an infant's neck. It should be understood within the scope of the present invention that the fasteners 30, 35 could be manufactured from suitable elements such as but not limited to snaps or hook and loop material. Additionally, it is contemplated within the scope of the present invention that the bib with pacifier 100 could employ alternate quantities of fasteners 30, 35 that is greater than or less than the quantity of fasteners illustrated herein.

Secured to the body 10 along the upper perimeter edge 15 in general axial alignment with midpoint 16 is the first attachment member 40. The first attachment member 40 includes a first end 41 and second end 42 and is elongated in shape being secured to the body 10 so as to create a loop shape. The first attachment member 40 is secured at first end 41 and second end 42 employing keepers 43 and it should be understood that the second end 42 is releasably secured in order to exchange the pacifier member 60. It should be understood within the scope of the present invention that the first attachment member 40 can be provided in alternate lengths but a preferred embodiment is a length that maintains the pacifier member 60 proximate the upper perimeter edge 15.

The second attachment member 50 is secured to the body 10 along the upper perimeter edge 15 in general axial alignment with midpoint 16 being adjacent the first attachment member 40 having a void 55 therebetween. The second attachment member 50 includes a first end 51 and second end 52 and is elongated in shape being secured to the body 10 so as to create a loop shape. The second attachment member 50 is secured at first end 51 and second end 52 employing keepers 53 and it should be understood that the second end 52 is releasably secured in order to exchange the pacifier member 60. It should be understood within the scope of the present invention that the second attachment member 50 can be provided in alternate lengths but a preferred embodiment is a length that maintains the pacifier member 60 proximate the upper perimeter edge 15. The adjacent location of the first attachment member 40 and second attachment member 50 inhibits any lateral movement of the pacifier member 60 when released by a user of the bib with pacifier 100. Positioning the first attachment member 40 and second attachment member 50 on opposing sides of the axis of the midpoint 16 facilitates an ability to promote only a downward movement of the pacifier member 60 thus allowing the infant utilizing the bib with pacifier 100 to more easily retrieve the pacifier member 60.

The bib with pacifier 100 includes a pacifier member 60 secured to the first attachment member 40 and second attachment member 50. The pacifier member 60 includes a base member 61 being annular in shape having a first aperture 62 and a second aperture 63 formed therein. Contiguously formed the base member 61 is nipple member 64 wherein nipple member 64 extends outward from the base member 61. The arrangement of the first aperture 62 and second aperture 63 aligns with the first attachment member 40 and second attachment member 50 so as to promote the securing and movement limitations of the pacifier member 60 as described herein. While a first aperture 62 and a second aperture 63 has been illustrated and discussed herein, it should be understood within the scope of the present invention that alternate elements could be employed to facilitate releasable securing of the pacifier member 60.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A bib having a pacifier member releasably secured thereto wherein the bib comprises:
a bib body, said bib body being planar and being manufactured from a cloth material, said bib body having an upper perimeter edge extending intermediate a first upper corner and a second upper corner, said bib body having a first lateral edge extending downward from said first upper corner, said bib body having a second lateral edge extending downward from said second upper corner, said first lateral edge and said second lateral edge joining at a midpoint opposite said upper perimeter edge;
a first attachment member, said first attachment member having a first end and a second end, said first end of said first attachment member being secured to said bib body proximate said upper perimeter edge being offset to a first side of said midpoint, and said second end of said first attachment member being releasably securable to said first end of said first attachment member to form said first attachment member into a first loop;
a second attachment member, said second attachment member having a first end and a second end, said first end of said second attachment member being secured to said bib body proximate said upper perimeter edge being offset to a second side of said midpoint, and said second end of said second attachment member being releasably securable to said first end of said second attachment member to form said second attachment member into a second loop
said first end of said first attachment member and said first end of said second attachment member being oriented parallel to said upper perimeter edge and
said pacifier member releasably securable to said first loop and said second loop in a position which inhibits lateral movement of the pacifier member when secured.

2. The bib having the pacifier member releasably secured thereto as recited in claim 1, said pacifier member having a base member and a nipple member, said base member having a first aperture and a second aperture.

3. The bib having the pacifier member releasably secured thereto as recited in claim 2, wherein said first upper corner includes at least one fastener.

4. The bib having the pacifier member releasably secured thereto as recited in claim 3, wherein said second upper corner includes at least one fastener, said at least one fastener on said second upper corner configured to couple to the at least one fastener on said first upper corner.

5. The bib having the pacifier member releasably secured thereto as recited in claim 4, wherein said first attachment member is journaled through said first aperture of said base member.

6. The bib having the pacifier member releasably secured thereto as recited in claim 5, wherein said second attachment member is journaled through said second aperture of said base member.

7. The bib having the pacifier member releasably secured thereto as recited in claim 6, wherein said first attachment member and said second attachment member are on opposing sides of an axis extending through said midpoint.

8. The bib having the pacifier member releasably secured thereto as recited in claim 1, wherein said first attachment member and said second attachment member are position on an exterior surface of the bib when worn.
